(19) United States
(12) Patent Application Publication
(10) Pub. No.: US 2024/0030509 A1
(43) Pub. Date: Jan. 25, 2024

(54) METHOD FOR SAFE PYROLYSIS AND IMPURITY REMOVAL OF WASTE LITHIUM BATTERY AND APPLICATION

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(72) Inventors: Haijun YU, Foshan, Guangdong (CN); Yingsheng ZHONG, Foshan, Guangdong (CN); Yinghao XIE, Foshan, Guangdong (CN); Xuemei ZHANG, Foshan, Guangdong (CN); Changdong LI, Foshan, Guangdong (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(21) Appl. No.: 18/265,860

(22) PCT Filed: Dec. 30, 2021
(86) PCT No.: PCT/CN2021/142958

§ 371 Date: Jun. 7, 2023

(30) Foreign Application Priority Data
Jun. 30, 2021 (CN) 202110741421.X

(51) Int. Cl. H01M 10/54; C22B 1/02; C22B 7/00

(52) U.S. Cl. CPC H01M 10/54; C22B 1/02; C22B 7/008

(57) ABSTRACT

A method for removing impurities from a waste lithium battery safely through pyrolysis. The method may include: (1) performing primary roasting on electrode fragments of a waste lithium battery, quenching, and then layered screening to obtain a current collector fragment and an electrode material; (2) mixing and grinding the electrode material and a grinding aid, soaking the mixture in an alkali liquor, filtering and taking out filter residues to obtain electrode powder, and (3) performing secondary roasting on the electrode powder to obtain a positive electrode material.

### TECHNICAL FIELD

The present disclosure relates to the technical field of recycling an electrode material by a high-temperature process, and more particularly, to a method and application for removing impurities from a waste lithium battery safely through pyrolysis.

### BACKGROUND

At present, electrode materials are usually recycled by a wet process and a high-temperature process. In the high-temperature process, a metal shell of a waste lithium battery is broken into small particles by mechanical crushing, and an electrode material is separated from a waste electrode fragment by screening. Meanwhile, organic binders (such as polyvinylidene fluoride and polytetrafluoroethylene), conductive agents and organic solvents of the electrode material are pyrolyzed. After roasting at high temperature, there are many impurities in the electrode material, which cannot be effectively pyrolyzed: the organic binder (such as polyvinylidene fluoride and polytetrafluoroethylene), polyolefins (such as polypropylene and polyethylene) in a separator, conductive agents, carbonic esters (such as ethylene carbonate and methyl ethyl carbonate) in an electrolyte, plastic shell scraps of the waste lithium battery and the like, are still remained in the electrode material particles after pyrolysis at high temperature due to uneven heating. At the same time, mechanical crushing and screening cannot remove a small part of residual aluminum powder and copper powder in the electrode material particles. At a high temperature (greater than 1200° C.), a positive electrode material and the copper powder in the electrode material may react with the aluminum powder, and the reaction is as follows:

First stage:

LiNiₑCo_{f}Mn_{g}O₂→LiO+eNiO+f CoO+g MnO,e+f+g=1; (main reaction)

2Cu+O₂→2CuO.

Second stage:

eNiO+fCoO+gMnO+⅔(e+f+g)Al→⅓(e+f+g)Al₂O₃+eNi+fCo+gMn; (main reaction)

3CuO+2Al→3Cu+Al₂O₃.

The reaction rate in the second stage is extremely fast, and a large amount of heat is released in a short time, so that the temperature in the reaction area reaches over 2800° C., which can not only melt the electrode material near the reaction area, but also splash the high-temperature melt, and further melt through a refractory material of an inner wall of a heating furnace and the inner wall of the heating furnace, which is very dangerous.

There are more impurities in the electrode material, which not only affect the purity of the electrode material of the waste lithium battery, but also increase the complexity of the subsequent treatment of the electrode material, and also damage devices and increase unsafe factors to an electrode material treatment environment.

### SUMMARY

The present disclosure aims at solving at least one of the above-mentioned technical problems in the prior art. For this purpose, the present disclosure provides a method and application for removing impurities from a waste lithium battery safely through pyrolysis. The method eliminates residual organic binders, conductive agents, organic solvents, aluminum and other impurities in the electrode material of the waste lithium battery, and improves the purity of the electrode material and the safety during pyrolysis.

In order to achieve the above objects, the present disclosure adopts the following technical solutions.

A method for removing impurities from a waste lithium battery safely through pyrolysis, comprises the following steps of:

(1) performing primary roasting on electrode fragments of a waste lithium battery, quenching, and then layered screening to obtain a current collector fragment and an electrode material;

(2) mixing and grinding the electrode material and a grinding aid, soaking the mixture in an alkali liquor, filtering and taking out filter residues to obtain electrode powder; and

(3) performing secondary roasting on the electrode powder to obtain a positive electrode material.

Preferably, in step (1), the electrode fragment of the waste lithium battery is obtained by discharging and crushing the waste lithium battery.

The crushing mainly reduces the generation of fine particles of aluminum and copper, reduces impurity particles in the battery material, and is convenient for recycling the current collector fragment.

Preferably, in step (1), the quenching is to spray a freeze spray to cool the electrode fragment of the waste lithium battery to a temperature less than 50° C. within 90 seconds; and the freeze spray is cold air with a temperature less than 15° C.

Preferably, in step (1), the primary roasting is performed at a temperature of 420° C. to 600° C., and lasts for 45 minutes to 90 minutes.

Preferably, in step (1), the primary roasting is performed in an atmosphere of air or oxygen.

When the waste electrode fragment are roasted, an adhesion property of the binders (polyvinylidene fluoride and polytetrafluoroethylene) decrease and the electrode materials become brittle; meanwhile, a surface temperature of the waste electrode fragment is rapidly reduced, a notch of a collector (aluminum foil and copper foil) fragment on the waste electrode is thinner, the temperature of the notch part drops faster, a shrinkage force is generated first, and then the notch of the current collector fragment curls quickly, and the notch between the current collector fragment and the electrode material of the waste lithium battery is larger. After screening, the electrode material of the waste lithium battery is more likely to fall off.

Preferably, in step (1), an ultrasonic vibrating screen is used for the layered screening, and a mesh number of a parent net of the ultrasonic vibrating screen is 16 meshes or 20 meshes, a mesh number of a transition net of the ultrasonic vibrating screen is one of 100 meshes, 140 meshes or 200 meshes, and a mesh number of a sub-net of the ultrasonic vibrating screen is one of 500 meshes, 540 meshes or 600 meshes.

By adopting the ultrasonic vibrating screen for layered screening, the screening function of high precision and high mesh is utilized, and a narrow particle size range of the electrode material of the waste lithium battery can be controlled at the same time, which is beneficial to improving the screening accuracy and improving the discharging efficiency by 20% to 50%. When three layers of screening nets are used together, one ultrasonic vibrating screen may be connected with a plurality of electric energy/acoustic energy transducers at the same time, and can screen under different powers and vibration frequencies. The electrode material of the waste lithium battery has the features of certain adsorption and high static electricity during screening. These disadvantageous features can be solved by using the ultrasonic vibrating screen, so the electrode material and the collector can be separated efficiently by simple screening.

Screening and grading by the three layers of nets comprising the parent net, the transition net and the sub-net can well screen different types of material nets and recycle different materials in a targeted way. The parent net mainly intercepts the current collector fragments, the transition net intercepts the electrode material fragments containing more impurities, the sub-net intercepts some coarse particle electrode materials containing more impurities, and fine particle electrode materials pass through the sub-net. The electrode materials with different sizes and shapes intercepted by the parent net, the transition net and the sub-net are subjected to secondary screening and collection.

Preferably, in step (1), the electrode material refers to an electrode material fragment, a coarse particle electrode material and a fine particle electrode material.

Further preferably, the electrode material fragment and the coarse particle electrode material are crushed and screened to obtain coarse current collector particles and the coarse particle electrode material, and then the coarse particle electrode material is crushed and screened to obtain the fine particle electrode material.

Based on the removal of most aluminum and copper, the electrode fragment and the coarse particle electrode material are further crushed by a crusher, and pass through the sub-net, and meanwhile, the coarse particle collector which cannot be easily crushed is also recycled.

Preferably, in step (1), the current collector fragment is washed with water and dried, and then the current collector fragment is recycled.

Preferably, in step (2), the grinding aid is at least one of white carbon black, opal powder or quartz powder. (The main component of the white carbon black, the opal powder or the quartz powder is silicon dioxide) Preferably, in step (2), a mass ratio of the grinding aid to the electrode material is (0.1 to 0.5): 100.

Preferably, in step (2), the grinding lasts for 30 minutes to 120 min, and a number of revolutions of a grinding machine used for grinding is 300 rpm to 600 rpm.

Preferably, in step (2), the alkali liquor is one of sodium hydroxide, magnesium hydroxide, potassium hydroxide or calcium hydroxide.

Further preferably, an OH⁻ concentration of the alkali liquor is 0.01 mol/L to 0.2 mol/L.

Preferably, in step (2), the soaking lasts for 10 minutes to 15 minutes.

Preferably, in step (2), the method further comprises the steps of washing and drying the filter residue.

Preferably, in step (2), the filtered filtrate is supplemented with alkali, which may be used for soaking the ground electrode powder again.

Preferably, in step (3), the secondary roasting is performed at a temperature of 600° C. to 1000° C., and lasts for 60 minutes to 90 minutes.

Preferably, in step (3), the secondary roasting is performed in an atmosphere of air or oxygen.

The present disclosure further provides an application of the method in recycling electrode materials.

Compared with the prior art, the present disclosure has the following beneficial effects.

1. According to the method of the present disclosure, primary roasting is performed on the electrode fragment of the waste lithium battery to reduce the adhesion property of the binder, and rapidly reduce the surface temperature of the electrode fragment of the waste lithium battery simultaneously. Because the notch of the collector (aluminum foil and copper foil) fragment is thinner, the temperature of the notch part drops faster, the shrinkage force is generated first, and then the notch of the current collector fragment curls first. Therefore, the notch between the current collector fragment and the electrode material of the waste lithium battery is increased, and after screening, the electrode material of the waste lithium battery is more likely to fall off.

2. The method of the present disclosure uses the grinding aid to reduce the density of the electrode material and increase the uniformity of the ground electrode material, thus avoiding an agglomeration phenomenon when dry-grinding the electrode material, eliminating an electrostatic effect, promoting a reaction between the aluminum in the electrode material and dilute alkali, and reducing the temperature of the secondary roasting. Then the residual aluminum powder can be dissolved by soaking the electrode material with the alkali liquor, and the grinding aid will also be dissolved in the dilute alkali, so the dilute alkali can synchronously remove the aluminum and the grinding aid from the electrode material, and the filtered dilute alkali filtrate can be reused in alkali leaching of the electrode material of the waste lithium battery, thus reducing the alkali consumption.

3. The primary roasting of the present disclosure is for pyrolyzing most organic binders (such as polyvinylidene fluoride and polytetrafluoroethylene), conductive agents, organic solvents and other impurities, and the secondary roasting is for pyrolyzing and carbonizing a few residual impurities which cannot be pyrolyzed in the primary roasting.

### BRIEF DESCRIPTION OF DRAWINGS

The present disclosure will be further explained with reference to the accompanying drawings and embodiments hereinafter, wherein:

FIG. 1 is a process flow chart of Embodiment 1 of the present disclosure.

### DETAILED DESCRIPTION

The concepts and the technical effects produced of the present disclosure will be clearly and completely described in conjunction with the embodiments and the accompanying drawings so as to sufficiently understand the objects, the features and the effects of the present disclosure. Obviously, the described embodiments are merely some embodiments of the present disclosure, rather than all the embodiments. Other embodiments obtained by those skilled in the art without going through any creative effort shall all fall within the protection scope of the present disclosure.

### Embodiment 1

A method removing impurities from a waste lithium battery safely through pyrolysis of this embodiment comprises the following steps of:

(1) recycling a waste lithium battery, discharging and performing primary crushing to obtain waste electrode fragments with a length and width of 2 cm to 3 cm and a mass of 7.34 kg, placing the waste electrode fragments in a heating furnace for primary roasting for 45 minutes under the conditions of 586° C. and introducing oxygen, moving the roasted waste electrode fragments into a mesh basket and spraying cold air at 10° C. for quenching, selecting an ultrasonic vibrating screen for screening (16 meshes for a parent net, 100 meshes for a transition net, and 540 meshes for a sub-net), wherein the parent net collected current collector fragments, the transition net collected material fragments containing impurities, and the sub-net collected coarse particle electrode materials containing more impurities;

(2) washing and drying the current collector fragments trapped by the parent net, collecting the current collector fragment, crushing the electrode material fragments trapped by the transition net and the coarse particle electrode materials trapped by the sub-net into fine particles by a crusher, screening with the transition net and the sub-net of the ultrasonic vibrating screen for the second time, in the second screening, trapping and collecting the coarse current collector particles by the transition net, and using the coarse particle electrode material trapped by the sub-net for crushing into fine particles by the crusher again, and then screening the fine particles through the sub-net to obtain the electrode material;

(3) feeding white carbon black and the electrode material in a mass ratio of 0.41:100 into an oscillating ball mill with a number of revolutions of 540 rpm for grinding for 87 minutes, soaking in a sodium hydroxide solution with an OH⁻ concentration of 0.031 mol/L for 12 minutes, and filtering to obtain a filtrate and a filter residue, wherein the filtrate could be used for soaking the electrode powder again when being supplemented with alkali, and washing the filter residue with water and then drying the filter residue to obtain electrode powder; and

(4) moving the electrode powder to a heating furnace, and then roasting in the heating furnace at 755° C. for 87 minutes under the condition of introducing air to obtain 5.37 kg of positive electrode material.

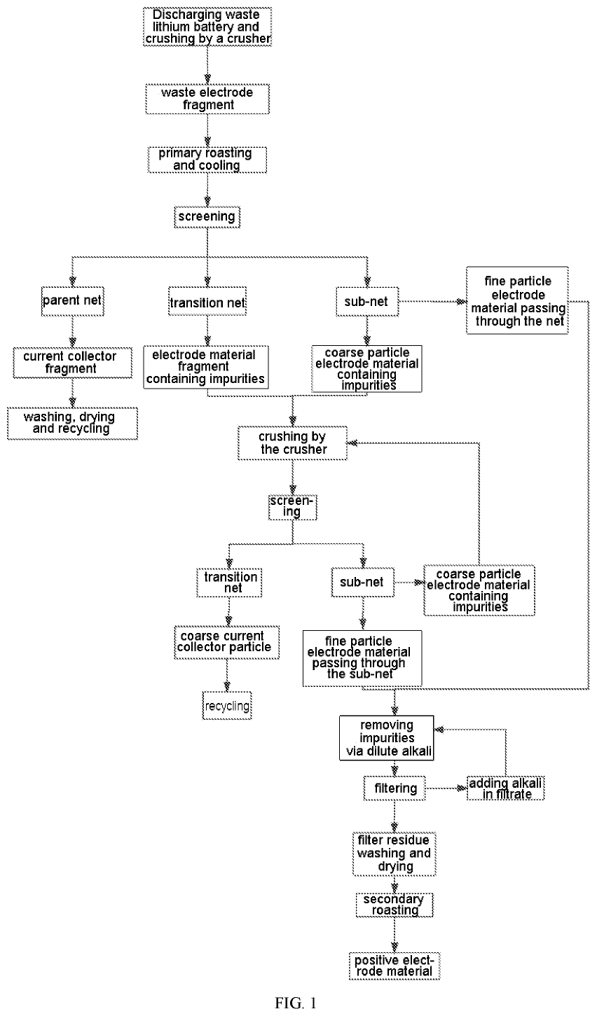

FIG. 1 is a process flow chart of Embodiment 1 of the present disclosure. It can be seen from FIG. 1 that the waste lithium battery is discharged and subjected to primary crushing to obtain the waste electrode fragments, and then subjected to primary roasting, cooling and screening, and then laminated and screened by using the ultrasonic vibrating screen, i.e., screened and graded by the three layers of nets comprising the parent net, the transition net and the sub-net, and then removed from impurities through the dilute alkali, filtered and subjected to secondary roasting to obtain the electrode powder.

### Embodiment 2

A method removing impurities from a waste lithium battery safely through pyrolysis of this embodiment comprises the following steps of:

(1) recycling a waste lithium battery, discharging and performing primary crushing to obtain waste electrode fragments with a length and width of 2 cm to 3 cm and a mass of 8.79 kg, placing the waste electrode fragments in a heating furnace for primary roasting for 69 minutes under the conditions of 550° C. and introducing oxygen, moving the roasted waste electrode fragments into a mesh basket and spraying cold air at 10° C. for quenching, selecting an ultrasonic vibrating screen for screening (20 meshes for a parent net, 100 meshes for a transition net, and 540 meshes for a sub-net), wherein the parent net collected current collector fragments, the transition net collected material fragments containing impurities, and the sub-net collected coarse particle electrode materials containing more impurities;

(2) washing and drying the current collector fragments trapped by the parent net, collecting the current collector fragment, crushing the electrode material fragments trapped by the transition net and the coarse particle electrode materials trapped by the sub-net into fine particles by a crusher, screening with the transition net and the sub-net of the ultrasonic vibrating screen for the second time, in the second screening, trapping and collecting the coarse current collector particles by the transition net, and using the coarse particle electrode material trapped by the sub-net for crushing into fine particles by the crusher again, and then screening the fine particles through the sub-net to obtain the electrode material;

(3) feeding white carbon black and the electrode material in a mass ratio of 0.27:100 into an oscillating ball mill with a number of revolutions of 480 rpm for grinding for 104 minutes, soaking in a dilute sodium hydroxide solution with an OH⁻ concentration of 0.157 mol/L for 10 minutes, and filtering to obtain a filtrate and a filter residue, wherein the filtrate could be used for soaking the electrode powder again when being supplemented with alkali, and washing the filter residue with water and then drying the filter residue to obtain electrode powder; and

(4) moving the electrode powder to a heating furnace, and then roasting in the heating furnace at 695° C. for 78 minutes under the condition of introducing air to obtain 6.64 kg of positive electrode material.

### Embodiment 3

A method removing impurities from a waste lithium battery safely through pyrolysis of this embodiment comprises the following steps of:

(1) recycling a waste lithium battery, discharging and performing primary crushing to obtain waste electrode fragments with a length and width of 2 cm to 3 cm and a mass of 3.37 kg, placing the waste electrode fragments in a heating furnace for primary roasting for 57 minutes under the conditions of 580° C. and introducing oxygen, moving the roasted waste electrode fragments into a mesh basket and spraying cold air at 10° C. for quenching, selecting an ultrasonic vibrating screen for screening (20 meshes for a parent net, 100 meshes for a transition net, and 600 meshes for a sub-net), wherein the parent net collected current collector fragments, the transition net collected material fragments containing impurities, and the sub-net collected coarse particle electrode materials containing more impurities;

(2) washing and drying the current collector fragments trapped by the parent net, collecting the current collector fragment, crushing the electrode material fragments trapped by the transition net and the coarse particle electrode materials trapped by the sub-net into fine particles by a crusher, screening with the transition net and the sub-net of the ultrasonic vibrating screen for the second time, in the second screening, trapping and collecting the coarse current collector particles by the transition net, and using the coarse particle electrode material trapped by the sub-net for crushing into fine particles by the crusher again, and then screening the fine particles through the sub-net to obtain the electrode material;

(3) feeding white carbon black and the electrode material in a mass ratio of 3:100 into an oscillating ball mill with a number of revolutions of 540 rpm for grinding for 76 minutes, soaking in a dilute sodium hydroxide solution with an OH⁻ concentration of 0.138 mol/L for 15 minutes, and filtering to obtain a filtrate and a filter residue, wherein the filtrate could be used for soaking the electrode powder again when being supplemented with alkali, and washing the filter residue with water and then drying the filter residue to obtain electrode powder; and

(4) moving the electrode powder to a heating furnace, and then roasting in the heating furnace at 845° C. for 67 minutes under the condition of introducing air to obtain 6.31 kg of positive electrode material.

### Embodiment 4

A method removing impurities from a waste lithium battery safely through pyrolysis of this 20 embodiment comprises the following steps of:

(1) recycling a waste lithium battery, discharging and performing primary crushing to obtain waste electrode fragments with a length and width of 2 cm to 3 cm and a mass of 7.83 kg, placing the waste electrode fragments in a heating furnace for primary roasting for 68 minutes under the conditions of 490° C. and introducing oxygen, moving the roasted waste electrode fragments into a mesh basket and spraying cold air at 10° C. for quenching, selecting an ultrasonic vibrating screen for screening (16 meshes for a parent net, 200 meshes for a transition net, and 600 meshes for a sub-net), wherein the parent net collected current collector fragments, the transition net collected material fragments containing impurities, and the sub-net collected coarse particle electrode materials containing more impurities;

(2) washing and drying the current collector fragments trapped by the parent net, collecting the current collector fragment, crushing the electrode material fragments trapped by the transition net and the coarse particle electrode materials trapped by the sub-net into fine particles by a crusher, screening with the transition net and the sub-net of the ultrasonic vibrating screen for the second time, in the second screening, trapping and collecting the coarse current collector particles by the transition net, and using the coarse particle electrode material trapped by the sub-net for crushing into fine particles by the crusher again, and then screening the fine particles through the sub-net to obtain the electrode material;

(3) feeding opal powder and the electrode material in a mass ratio of 0.14:100 into an oscillating ball mill with a number of revolutions of 540 rpm for grinding for 69 minutes, soaking in a dilute potassium hydroxide solution with an OH⁻ concentration of 0.175 mol/L for 15 minutes, and filtering to obtain a filtrate and a filter residue, wherein the filtrate could be used for soaking the electrode powder again when being supplemented with alkali, and washing the filter residue with water and then drying the filter residue to obtain electrode powder; and

(4) moving the electrode powder to a heating furnace, and then roasting in the heating furnace at 755° C. for 75 minutes under the condition of introducing air to obtain 5.64 kg of positive electrode material.

### Comparative Example 1

A method removing impurities from a waste lithium battery safely through pyrolysis of this comparative example comprises the following steps of:

(1) recycling a waste lithium battery, discharging and performing primary crushing to obtain waste electrode fragments with a length and width of 2 cm to 3 cm and a mass of 7.45 kg, placing the waste electrode fragments in a heating furnace for cooling at normal temperature for 53 minutes under the conditions of 615° C. and introducing oxygen, selecting an ultrasonic vibrating screen for screening (16 meshes for a parent net, 140 meshes for a transition net, and 500 meshes for a sub-net), wherein the parent net collected current collector fragments, the transition net collected material fragments containing impurities, and the sub-net collected coarse particle electrode materials containing more impurities;

(2) washing and drying the current collector fragments trapped by the parent net, collecting the current collector fragment, crushing the electrode material fragments trapped by the transition net and the coarse particle electrode materials trapped by the sub-net into fine particles by a crusher, screening with the transition net and the sub-net of the ultrasonic vibrating screen for the second time, in the second screening, trapping and collecting the coarse current collector particles by the transition net, and using the coarse particle electrode material trapped by the sub-net for crushing into fine particles by the crusher again, and then screening the fine particles through the sub-net to obtain the electrode material;

(3) feeding white carbon black and the electrode material in a mass ratio of 0.43:100 into an oscillating ball mill with a number of revolutions of 480 rpm for grinding for 72 minutes, soaking in a dilute sodium hydroxide solution with an OH⁻ concentration of 0.076 mol/L for 14 minutes, and filtering to obtain a filtrate and a filter residue, wherein the filtrate could be used for soaking the electrode powder again when being supplemented with alkali, and washing the filter residue with water and then drying the filter residue to obtain electrode powder; and

(4) moving the electrode powder to a heating furnace, and then roasting in the heating furnace at 850° C. for 74 minutes under the condition of introducing air to obtain 5.64 kg of positive electrode material.

### Comparative Example 2

A method removing impurities from a waste lithium battery safely through pyrolysis of this comparative example comprises the following steps of.

(1) recycling a waste lithium battery, discharging and performing primary crushing to obtain waste electrode fragments with a length and width of 2 cm to 3 cm and a mass of 8.07 kg, placing the waste electrode fragments in a heating furnace for primary roasting for 45 minutes under the conditions of 585° C. and introducing oxygen, moving the roasted waste electrode fragments into a mesh basket and spraying cold air at 10° C. for quenching, selecting an ultrasonic vibrating screen for screening (16 meshes for a parent net, 200 meshes for a transition net, and 600 meshes for a sub-net), wherein the parent net collected current collector fragments, the transition net collected material fragments containing impurities, and the sub-net collected coarse particle electrode materials containing more impurities;

(2) washing and drying the current collector fragments trapped by the parent net, collecting the current collector fragment, crushing the electrode material fragments trapped by the transition net and the coarse particle electrode materials trapped by the sub-net into fine particles by a crusher, screening with the transition net and the sub-net of the ultrasonic vibrating screen for the second time, in the second screening, trapping and collecting the coarse current collector particles by the transition net, and using the coarse particle electrode material trapped by the sub-net for crushing into fine particles by the crusher again, and then screening the fine particles through the sub-net to obtain the electrode material;

(3) feeding the electrode material into an oscillating ball mill with a number of revolutions of 540 rpm for grinding for 78 minutes, soaking in a dilute potassium hydroxide solution with an OH-concentration of 0.094 mol/L for 15 minutes, and filtering to obtain a filtrate and a filter residue, wherein the filtrate could be used for soaking the electrode powder again when being supplemented with alkali, and washing the filter residue with water and then drying the filter residue to obtain electrode powder; and

(4) moving the electrode powder to a heating furnace, and then roasting in the heating furnace at 780 for 87 minutes under the condition of introducing air to obtain 6.24 kg of positive electrode material.

TABLE 1
Detection values of aluminum and carbon in electrode materials
of Embodiments 1, 2, 3 and 4 and Comparative Examples 1 and 2

| | Aluminum | Aluminum | Carbon | Carbon |
|---|---|---|---|---|
| | content | content | content | content |
| | before | after | after | after |
| | dilute alkali | dilute alkali | primary | secondary |
| Treatment | treatment | treatment | roasting | roasting |
| group | (%) | (%) | (%) | (%) |
| Embodiment1 | 0.78 | 0.051 | 0.67 | 0.017 |
| Embodiment 2 | 0.33 | 0.046 | 0.45 | 0.013 |
| Embodiment 3 | 0.61 | 0.048 | 0.88 | 0.018 |
| Embodiment 4 | 0.69 | 0.031 | 0.71 | 0.015 |
| Comparative | 0.91 | 0.21 | 0.83 | 0.023 |
| Example 1 | | | | |
| Comparative | 0.78 | 0.15 | 0.91 | 0.031 |
| Example 2 | | | | |

It can be seen from Table 1 that the positive electrode materials obtained through removing impurities by pyrolysis through the methods of Embodiments 1 to 4 of the present disclosure have low aluminum content, while the method of Comparative Example 1 is slow cooling at normal temperature, which is not conducive to the small curling degree of the current collector fragment, resulting in that the notch between the current collector fragment and the electrode material of the waste lithium battery is reduced, and the electrode material of the waste lithium battery after screening is not easy to fall off, so that the aluminum content before the dilute alkali treatment is high. In Comparative Example 2, no grinding aid is added, which will cause an agglomeration phenomenon that is unfavorable to particle dispersion, resulting in a larger particle size which is unfavorable to dispersion of carbonized scabs by roasting the binders, conductive agents, and organic solvents, and thus unfavorable to reaction between aluminum and dilute alkali, resulting in aluminum residue after the dilute alkali treatment.

The embodiments of the present disclosure are described in detail, but the present disclosure is not limited to the above embodiments, and various changes may also be made within the knowledge scope of those of ordinary skills in the art without departing from the purpose of the present disclosure. In addition, in case of no conflict, the embodiments in the application and the features in the embodiments may be combined with each other.

1. A method for removing impurities from a waste lithium battery safely through pyrolysis, comprising the following steps of:
(1) performing primary roasting on electrode fragments of a waste lithium battery, quenching, and then layered screening to obtain a current collector fragment and an electrode material; wherein in step (1), an ultrasonic vibrating screen is used for screening, and a mesh number of a parent net of the ultrasonic vibrating screen is 16 meshes or 20 meshes, a mesh number of a transition net of the ultrasonic vibrating screen is one of 100 meshes, 140 meshes or 200 meshes, and a mesh number of a sub-net of the ultrasonic vibrating screen is one of 500 meshes, 540 meshes or 600 meshes:
(2) mixing and grinding the electrode material and a grinding aid, soaking the mixture in an alkali liquor, filtering and taking out filter residues to obtain electrode powder; and
(3) performing secondary roasting on the electrode powder to obtain a positive electrode material: wherein the secondary roasting is performed at a temperature of 600° C. to 1000° C., and lasts for 60 minutes to 90 minutes, and the secondary roasting is performed in an atmosphere of air or oxygen.

2. The method of claim 1, wherein in step (1), the primary roasting is performed at a temperature of 420° C. to 600° C., and lasts for 45 minutes to 90 minutes, and the primary roasting is performed in an atmosphere of air or oxygen.

3. (canceled)

4. The method of claim 1, wherein in step (1), the quenching is to spray a freeze spray to cool the electrode fragment of the waste lithium battery to a temperature less than 50° C. within 90 seconds; and the freeze spray is cold air with a temperature less than 15° C.

5. The method of claim 1, wherein in step (2), the grinding aid is at least one of white carbon black, opal powder or quartz powder.

6. The method of claim 1, wherein in step (2), a mass ratio of the grinding aid to the electrode material is (0.1 to 0.5): 100.

7. The method of claim 1, wherein in step (2), the alkali liquor is one of sodium hydroxide, magnesium hydroxide, potassium hydroxide or calcium hydroxide.

8. The method of claim 1, wherein in step (2), an OH⁻ concentration of the alkali liquor is 0.01 mol/L to 0.2 mol/L.

9. (canceled)

10. (canceled)
